(19) United States
(12) Patent Application Publication
(10) Pub. No.: US 2002/0099816 A1
(43) Pub. Date: Jul. 25, 2002

(54) Internet performance system

(76) Inventors: John S. Quarterman, Austin, TX (US); Donald Fussell, Austin, TX (US); Andrew Scherrer, Ham Lake, MN (US); Peter H. Salus, Austin, TX (US); Paul Murphy, Edinburg (GB); Shaun Dawson, Dallas, TX (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/834,333

(22) Filed: Apr. 13, 2001

Related U.S. Application Data
(60) Provisional application No. 60/198,783, filed on Apr. 20, 2000.

(51) Int. Cl. G06F 15/173

(52) U.S. Cl. 709/224

(57) ABSTRACT

A method for monitoring of network performance is defined. The method includes the steps of defining and characterizing the population of interest (the set of hosts and networks in which there is interest); choosing a set of destinations that represent the population (pinglists) including categorization structure (viewlists); monitoring the destinations in the pinglists from one or more vantage points (beacons) and collecting information therefrom; compiling and summarizing the data in ways that address questions of interest about the population; and providing an appropriate interpretation of the analysis in terms of the questions of interest.

### CROSS-REFERENCE TO RELATED APPLICATIONS

This application claims the priority of application Ser. No. 60/198,783, which was filed Apr. 20, 2000 and is incorporated herein by reference.

### FIELD OF THE INVENTION

The invention relates to the field of computer networking. More specifically, the invention relates to a system and method for internet monitoring.

### BACKGROUND OF THE INVENTION

Computer networks are known to exhibit delays, the causes for which may be difficult to identify. This is especially true of the internet. Internet Service Providers, referred to hereinafter as ISPs, are central to the transmission of all types of Internet data. All ISPs are different, and many are not appropriately comparable with one another. Thus, a need exists for a method and system for monitoring and comparing internet performance, including individual nodes and ISPs.

### SUMMARY OF THE INVENTION

The present invention detects and diagnoses performance problems in customer intranet and ISP networks, and provides benchmarks against similar networks, as well as interpretation for capacity planning.

The invention provides a framework for reasonable comparison of performance characteristics, implemented by a third party. An example of this is given on the publicly available site, http://ratings.miq.net/. However the web site provides only a small sample of the capabilities of the invention. MIQ can provides detailed and comprehensive comparisons of performance characteristics.

The invention provides a user-eye view of Internet performance, by using such metrics as latency, packet loss, reachability, uptime, etc., to compare ISPs for marketing purposes and to determine and display engineering problems in customer ISPs which those ISPs can then address.

The types of performance information which the invention provides are quite expansive. The invention is able to detect outages and other unusual performance events, especially those that affect large numbers of providers (e.g., when an interconnect goes down). The detection methods are tuned to notice any events that are likely to impact user experience, operating in as near real time as possible. Data from all such events is logged into an archive of many different types of events. These historical events are then used for comparison with any new events that occur. Purely momentary individual events are logged, but do not typically enter into the actual reports. Outage-reporting is a matter of customization for each subscriber.

The invention can also relate to isolation. It is desirable to isolate the causes of events to individual rosters and links where possible. The process by which this is achieved includes identification and geographical localization of affected hosts.

Characterization is another aspect of the invention. When events are detected and archived as described above, the underlying data can be processed by a suite of tools that help discern the nature of the event, such as routing flap, link outage, bogus route announcements, sudden traffic burst, equipment failure, equipment overload, denial of service (DOS) attacks, or slashdot effect. Through successful characterization, the ISP's correction of any problems can be facilitated, or it can be confirmed that problems are outside the provider's jurisdiction (e.g., in a peering network).

The invention also relates to prediction of when problems will become acute.

The invention provides data for comparison of ISP performance. One embodiment makes comparisons of ISPs based on multiple (approximately 6) metrics per ISP, including, Round-trip Latency, Packet Loss, Reachability (of destination hosts), Web access/retrieval time, FTP bulk transfer time, and DNS lookup time.

Comparison data is summarized in ways that facilitate reasonable comparisons, and the comparison data is supplemented with information that cultivates appropriate interpretation of multiple metrics taken together, and how they are likely to impact different network applications.

The methodology disclosed herein is applicable to the entire Internet, including ISPs that are not customers of the invention user. The end result is thus improved service throughout the Internet. The various aspects of the invention can be applied to Enterprise networks and Intranets as well as the Internet.

One preferred method for monitoring of network performance includes the steps of defining and characterizing the population of interest (the set of hosts and networks in which there is interest); choosing a set of destinations that represent the population (pinglists) including categorization structure (viewlists); monitoring the destinations in the pinglists from one or more vantage points (beacons) and collecting information therefrom; compiling and summarizing the data in ways that address questions of interest about the population; and providing an appropriate interpretation of the analysis in terms of the questions of interest.

The invention can utilize NINM (non-Instrumented Network Monitoring), as contrasted with SNMP (RFCs 2271-2275) instrumented monitoring. This permits the collection of information on ISPs that are not customers of the user for comparison with ISPs that are customers of the user.

Of significant interest is ISP performance. From an ISP-centric view, other portions of the Internet on which one may care to focus can be evaluated.

Also of significant interest is performance of the Internet itself, more so than performance of only a single specific application such as web servers. A collection of many Internet services can be identified, each of which is measured by several metrics. Investigation of relationships allows for understanding relationships between performance measures of these different services.

The meaning of data should retain consistency regardless of the target population. There are numerous interesting ways to subset the Internet. Any monitoring effort must be able to provide information about the performance and behavior of any such subset, such as per ISP or per end-user application. The same aspects of performance should be reflected as those that constitute a user's perception of performance and network quality. Finally, numerical results should be delivered which are interpreted according to the needs of the application or the user for which the network is performing.

Standards for network behavior are highly dependent on the task that is being performed. For example, it is desirable for large bulk transfers to proceed rapidly in terms of bits per second, it is not of particular concern whether the latency is 100 ms or 300 ms (except through the relationship between latency and bandwidth). Therefore, any numerical results must be interpreted according to the needs of the application or the user for which the network is performing. For this reason multiple metrics are used.

Another aspect of the invention is the ability to avoid bias in interpretation of monitoring efforts. There are many ways to introduce bias into an evaluation of this nature, from the definition of a population and data collection methodology, to the presentation and interpretation of the results. Whether intentional or not, many such biases arise from overgeneralization, or inappropriate comparisons, and rely on complexity and ignorance to deliver a distorted picture of what is really going on.

Another advantage of the invention is the ability to accommodate scaling. Aspects of the system should be scalable so that at least the majority of the larger ISPs can adequately be covered and the whole Internet can be addressed. Scaling concerns cover processes including data collection (increasing numbers of pinglists and therefore destinations), transfer of data from multiple beacons to a central data storage facility, archiving data, computation, and various routine processing, including periodic updates of summaries and displays.

This standardized monitoring can be used to complement and validate the user's own proprietary techniques.

### DETAILED DESCRIPTION OF A PREFERRED METHODOLOGY

The first step in performing analysis according to this embodiment is defining the target Population; that is, the set of hosts and networks in which there is interest. The Internet is both immense and extremely complex. While technically, it consists of nodes connected by links for the purpose of data transmission, the Internet hosts a myriad of activities. Therefore, people are often concerned with some part of the whole. The careful definition of the population of interest is critical in the proper interpretation of any data that is collected. While any part of the Internet is likely to have its own unique characteristics, there are ways to determine useful criteria for categorizing different aspects of any sub-population.

In order to effectively address the right questions about a sub-population in the most appropriate manner attainable, a flexible classification approach that allows for in-depth study of any sub-population in a consistent manner is provided. This approach defines a profile for classifying a network that consists of 2 levels of grouping: first by ISP, then by service types.

Then ISP Grouping will be described first. ISPs are central to the transmission of all types of Internet data. For this reason, performance is viewed by centering on its characteristics within and between ISPs. All ISPs are different, and many are not appropriately comparable with one another. Therefore, some classification is necessary before any comparisons are sensible. Criteria for classification are based on three major factors, size, distribution and emphasis.

There are many criteria for determining size. One criteria is a rough estimate of capacity to determine the largest ISPs. ISPs generally have a good idea of their size, and there is a rather strong consensus among ISPs as to which ISPs are the biggest. Small ISPs tend to be local to a city or metropolitan region or state, and thus also easy to distinguish. Mid-size ISPs are all the others. When a specific distinguishing factor is needed, numbers of supercore routers may be utilized: big ISPs have at least 6; mid-size ISPs have at least 3; small ISPs have at least one. There are also many other ways of sizing ISPs, such as by numbers of PoPs, numbers of users volume of traffic, etc. Many such measures of ISP size and related data can be estimated.

Example ISP Size Categorization Scheme:

| ISP Size # | supercore # | routers # | Web # | other # | total # |
|---|---|---|---|---|---|
| Lit | 1 | 4 | 6 | 10 | 20 |
| Mid | 3 | 100 | 18 | 25 | 55 |
| Big | 6 | 500 | 55 | 100 | 180 |

(Lit, Mid and Big are the terms used for little, mid-sized, and big.

Distribution can be expressed in terms of local, national, or world geography, depending somewhat on size. Once again, ISPs tend to know which category they fit in. Worldwide ISPs especially insist on being classed as such.

Emphasis is a quantification in relation to any important aspects of an ISP that are not covered by some measure of size or regional distribution. Examples might be those ISPs who only support corporate customers, or who do colocation and don't provide general dialup services.

After grouping by ISP, the different functional roles or services provided by any group of nodes on the Internet is explored. Examples of roles which can be compared across ISPs include mail servers, DNS servers, routers, supercore, core, leaf dialup, web servers, game servers, chat servers, ftp-only sites, news services, search engine, other popular services.

The next step is sampling, which involves choosing a set of Destinations that represent the Population. There are 2 levels on which sampling is defined: (1) how is the ISP characterized, (Size, Distribution, Emphasis), and (2) how do we sample destinations within the ISP to match the characterization.

The Size and Distribution dictate the total number of destinations included in the pinglist, and where the destinations come from geographically. The second (2) reflects the emphasis. It is a relative weighting, relating to the determination of how many hosts represent each of the service categories.

Pinglists are used to group all of the monitored destinations by ISP. Pinglists dictate the destinations to which probes are sent. Viewlists are then used for organizing the summarization and presentation of the data once it has been collected.

### Size

Many different measures related to ISP Size can be deduced. Periodically one node per every organizational domain (such as utexas.edu, ibm.com, ucl.ac.uk) is tracerouted on the Internet worldwide. The resulting data is then used to determine Internet and ISP topology, link capacity, customers, etc. For example, it is straightforward to tell what domains belong to customers of a given ISP, simply by noting which ISP owns the last hop before the customer domain. The measures which can be deduced include: number of internal links number of external links: number of routers; number of supercore routers; number of PoPs; geographical location of each node; number of customer domains; capacities of links; number of cities connected; and number of countries connected. While approximate, these numbers provide information that serves three basic purposes. (1) They help determine which ISPs should be comparable. (2) They aid in construction of initial pinglists and viewlists; and (3) These derivative measures are often of interest in themselves.

### Pinglists

Pinglists list destinations that are pinged, or otherwise probe the other metrics. Pinglists reflect the sampling design underlying the entire data collection process.

### Generation

The representativeness of a pinglist is derived from the attributes that characterize the ISP. We design each pinglist to reflect with accuracy the size and emphasis of the ISP that we are monitoring with that pinglist; in terms of services that ISP provides, its geographical distribution, and the type of customers it serves. Initial pinglists and categorized viewlists can be created from a set of traceroutes. Vast quantities of traceroute data and lists of host names organised by top-level domain are commerciaslly available from Matrix.net of Austin Tex.

The procedure for generating pinglists is as follows.

1. Determine the DNS zone or zones used by the customer.

2. If the determination does not generate a sufficient set of destinations then further information can be obtained by pointing dig at the domain's name server: dig@<primary> <zone> axfr

3. if axfr does not produce data (if zone transfers are not permitted) then A, NS, MX and CNAME may produce useful information.

4. grep for the zones in the traceroute data /map/traceroute/world/world.nodes—use all of the nodes listed here in the ping list

5. zgrep for the zones in the appropriate TLD files in /map/zone/9807/9807.hosts/—be selective about using the hosts listed in here, as there may be a lot of junk/workstation/wasteful entries. These can often be recognised from the hostname.

6. For most ISPs offering dial up service, this is quite a big issue. For example, demon. co. uk has a unique A record per customer, since they do static IP.

7. Many ISPs have huge blocks of DNS which are something like (dynamic,slip,ppp)—<m>. (shiva,lras,ascend,max,tnt)—<n> .noc.region.isp.net, where m and n are quite large. Others have large LAN DHCP blocks published in DNS. The complexities of this process is why the traceroute data is preferable for finding ISP routers.

If 2) & 3) do not yield sufficient hosts to produce an “interesting” ping list, use dig@<primary> <zone> axfr to find more hosts.

The resulting list may be placed in a designated folder so that others can examine it.

The lists should be monitored carefully to make sure they continue to serve as a good representative of the entire Internet in general, and the user's customers in particular.

Prior to installing pinglists, they should be checked for RFC 1918 private addresses. These addresses may be used on enterprise networks, but must not be used on or publicised to the Internet. RFC 1913 addresses are the following address blocks:

10/8 (10.0.0.0->10.255.255.255)

172.16/12 (172.16.0.0->172.31.255.255)

192.168/16 (192.168.0.0->192.168.255.255)

If any RFC1918 addresses are present, the corresponding hostnames should be removed from the .raw file, and the .gw file regenerated prior to installation and distribution.

In addition to driving the mechanics of data collection, pinglists also are the statistical sample. All statistical validity of method results comes from the methods of building pinglists.

Pinglists aren't created by randomly choosing a subset of all the ISP's hosts. Rather, MIQ samples randomly within the groupings according to distribution and service type categories. This requires an understanding of the structure of the ISP's network. It is also the only way to ensure that the sample looks like the population —i.e., is representative.

2. Categorization

The categorization criteria described above, provide the basis for a profile that captures all the important attributes of the network defined. Pinglists are formed by selection of hosts that fit the ISP/Service type profile (described above), with careful attention to which categories are represented and in what proportions. The different categories of destinations are also determined from our traceroute data, via several indicators.

Supercore routers show many traversals, and they are closely meshed with other supercore routers in their ISP, while they have no direct connections outside of the ISP.

PoPs occur at the edges of ISPs just before customer nodes. The basic clue is the number of links branching out from the PoP, combined with a change of domain name or IP network number, and also clues in the domain names such as “isdn” or “ppp” or the like.

A customer node is a non-ISP node found in a traceroute just outside an ISP. The customer node is thus deduced to be a customer of that ISP. Some complexity may exist with regard to virtual web servers, but methods of detecting such servers are available.

A Point of Presence (PoP) is a telephone industry term that has been adopted by ISPs. It indicates a cluster of ISP equipment in a certain geographical location that is used to connect customer nodes. A PoP usually contains at least one router, but may contain multiple routers, as well as DNS servers, web servers, etc.

Core routers are regional or organizational routers between PoP and supercore routers.

Ordinary routers are routers that are not otherwise distinguished. They are sometimes called transit routers and are in between other routers. These types of routers tend to show the most variation in latency. Some ISPs have transit routers that are only visible from paths that traverse certain pairs of PoP and supercore routers.

Web servers are normally leaf nodes and usually have www in their names. In addition, they normally respond to HTTP on TCP port 80.

DNS servers may be located by using DNS itself. They also respond to DNS queries. Many ISPs supply two different kinds of DNS service, the first about the ISP itself, and the second for customer domains.

Mail servers are detectable via DNS MX records and because they respond to SMTP queries on TCP port 25.

Initial pinglists may serve as mere approximations of a representative sample and some oversights or errors in the list acceptable for most purposes. It is preferable that the user encourage input from the ISPs on the makeup of the pinglists that represent them.

3. Pinglist Maintenance

To remain representative of a population, pinglists must track the changes in the network they represent, as hosts are added, removed, or converted to different purpose. Destinations are preferably removed when they have been inactive for 31 days. Pinglists are preferably checked for this on a weekly basis. New destinations will be added as the ISP grows and changes in the types of service they provide.

Thus, to maintain a pinglist, a user is advised to (1) remove (weed out) hosts that are really dead, so as not to artificially inflate the “packet loss” estimates; and (2) have a mechanism for adding new destinations to a pinglist, either because the ISP grows, or because one host that was weeded is replaced in function by a different host. This should include a channel through which the ISP can inform to about changes they make in their network.

Certain rules for weeding of pinglists are optimally followed. Pinglists should not contain: (1) destinations on/through an ISDN line or similar transitory or expensive link. (Unless specifically requested.); (2) workstations or the like (i.e. machines which for whatever reason will be periodically switched off in the normal course of operation); (3) duplication, such as duplicate entries representing the same machine or multiple interfaces on the same machine (excepting when monitoring both sides of IX connections to ISPs.); (4) multiple machines inside a high performance network/lan viewed through a single (or small set of) gateway machines, except in certain circumstances, such as a web email provider with forty customer facing servers on a single high performance internal network because a user would likely not want to hit all of those machines, since the number which are available at any particular time affects service quality; (5) machines requested not to be pinged by their owners.

Weeding should remove the unwanted destinations from beacon pinglists as promptly as is practicable.

Weeding should not remove destinations that are simply down for maintenance. A note however should, however, be made that the destinaiton should be removed temporarily from processing.

It may be desirable to treat new pinglists differently from established ones. For example, more aggressive weeding is appropriate for new lists. Established pinglists are more appropriately weeded via viewlist intermediary stage to recover from false positive(s) in the weeding process.

It is preferable that a user evaluate and use as appropriate any feedback received from whatever source. It is also noteworthy that the analysis required for weeding may produce useful categorisation information

There are two main routes which a user can use to add new hosts to pinglists. One is by direct contact with the ISP in question, the other is indirect and relates to the gathering of new traceroute data.

Direct Contact involves contacting the ISP to be added. When an ISP is added to the set of pinglists, the ISP should be informed that their network is being monitored; provided with a list of hosts that are included in the pinglist; requested to provide feedback about which hosts are in that list but should not be, and which hosts are not in that list but which should be; and provided with a user contact should they wish to make updates or request information in the future. Feedback from the ISP should then be used to update the pinglist.

When a new set of traceroute data is gathered, the same procedure that is followed for creating a new pinglist should be followed for all the existing pinglists. Any new hosts, found from the new traceroute data should be added to the pinglist for that ISP (the existing hosts being retained).

### Sample size

The amount of data collected is determined by the number of destinations being monitored and the frequency with which those destinations are sampled.

The size of a pinglist will be governed by the size of the ISP being monitored, as well as the number of different service areas they represent. The size of pinglists therefore ranges from several dozen to many hundreds of destinations. A large portion of these destinations will be routers, since this service is at the heart of network performance.

It has been proposed that pinging routers may be of little value, since they may drop or delay ping responses. However, this is not uniformly true across all routers. Supercore routers tend to show quite stable response until a major performance event intervenes, and then the delay in ping response is more likely to be in intervening nodes than in the supercore routers themselves. Ordinary routers do vary the most quickly in ping response with load of any of the types of destinations which have been monitored. That response in itself quickly reveals when an ISP is loaded. DNS and news servers tend to vary the least in ping response with ISP load. Dialup and core routers show intermediate response. Comparisons of ping results among these types of destinations is much more informative than pinging only types of destinations that show the least reaction to load. In addition, pinging large numbers of destinations of all types greatly facilitates isolating performance problems to specific parts of the ISP and characterizing the type of performance event.

The frequency with which those destinations are sampled is also important. In this embodiment, optimal monitoring occurs at 15 minute intervals. This interval allows for a high resolution summary of performance conditions through time, as well as rapid detection of problems or other events when they occur.

Considerations with respect to sample size involve a tradeoff between adequate coverage and the problems of collecting and processing the resulting data. The beacons or the network on which they operate must not be significantly affected by the monitoring packets. Otherwise, biases may be introduced into the data due to the data collection process itself. To avoid introducing bias, the user preferably performs quality control to ensure that the frequency of sampling and the number of destinations sampled are not so high that they significantly affect the data collection process.

There are other concerns about more frequent probing of certain destinations, to improve the time resolution for detecting certain types of events. This may involve continuous frequent monitoring of smaller numbers of hosts or the turning on/off of monitoring in response to event detection from the 15 minute samples.

Data Collection relates to monitoring the destinations in the Pinglists from one or more vantage points (Beacons). For each ISP, a list is created of several dozen to several hundred destinations that belong to that ISP's network. These lists are pinglists, described above. It should be noted however, that monitoring does not rely solely on ICMP packets. Data collection commences when a pinglist is activated for one or more beacons.

Each beacon scans each pinglist every 15 minutes. In each scan, each beacon sends several measurement packets to each destination per pinglist. A scan may entail measurement data of several different types, depending on the metric. Each packet is intended to elicit a response from its destination. The responses to groups of measurement packets (bongs) are recorded by the beacon as raw data.

Data collection occurs continuously through time, accumulating successive scans. Therefore, the data recorded about a particular metric, by a single beacon, from a certain pinglist comprise a data stream. Data streams are periodically sent back to a data center, where the streams from multiple beacons are subjected to processing and statistical analysis for various displays.

One method of monitoring is Non Instrumented Network Monitoring (NINM). An embodiment of the invention emphasizes data collection that does not involve instrumenting the subscriber's rosters or other nodes. This permits a return of uniform metrics even for non-subscriber ISPs. It also permits coverage of the entire Internet. NINM is carried out by issuing a series of scans, each of which sends test packets to all destinations within a given Pinglist. These test packets are sent from multiple vantage points, or Beacons, and serve to account for multiple performance metrics.

A tomographic approach can be contrasted to end to end measurements. Various embodiments of the present invention may be referred to as tomography, because they use a relatively small number of beacons to monitor a very large number of destinations, and those destinations are at all levels of the Internet, including routers, mail servers, FTP servers, and others, not just web servers.

Conventional approaches fail to give the same, detailed landscape view of the network of networks (the Internet) that the present invention provides. Application monitoring counts and tabulates traffic transmitted by different applications that use the network, but does no monitoring of the intervening network. Beacon-to-beacon or end-to-end measurements provide data only about paths between two specific points, rather than an entire network.

### Multiple Beacons

Monitoring is conducted from beacons placed at multiple vantage points, emphasizing coverage both in terns of routing topology and geography. Moreover, the scans sent from each beacon are synchronized so that each scan of Pinglist destinations occurs at nearly the same time, rather than randomly throughout some interval.

The most important reason for monitoring an ISP from multiple beacons is so that events can be detected with confidence by observing those events from multiple points of view. An event observed by only one beacon might be an artifact in that beacon; an event observed by several beacons is probably a real event. An artifact could be an overloaded local network link or an overloaded CPU on the beacon. While both of these artifacts are unlikely, similar artifacts could be caused by congestion in a link near the beacon inside its ISP. Real events of any size should be visible from multiple beacons. This is analogous to the way an image seen by only one eye could be a floater in the eye, while an image seen by both eyes is probably outside of either eye. The present invention has many eyes, or beacons, with which to triangulate on specific events. For example, a recent congestion event occurred primarily in the northeastern region of one ISP. If that event was seen from only one beacon that is located in that region of that ISP, we might mistake the event for an artifact in or near the beacon. But because the event was seen from multiple beacons, both inside and outside of that ISP, it was know to be real. And thus, it was known that the beacon inside that region of the ISP was showing real data about the event, which could be used to more precisely determine the nature of the event.

Network performance has different aspects, which, while related, demand distinct metrics. It is contemplated that measurement and reporting be performed on approximately six performance metrics: round trip latency, packet loss, reachability, bulk transfer (throughput), web page retrieval time (several parts), and DNS name lookup.

Ideally, all services are monitored using packets of the same protocol and behavior as the service being monitored. So, for example, WWW servers are monitored using HTTP-type TCP packets. DNS servers are monitored using real name lookups. For FTP servers actual files are transferred.

In general, ICMP (ping) packets are used to monitor things of interest. This is advantageous because it provides a uniform packet type to apply across all protocols and service, and thus provides a means by which interpretation of the performance numbers, and translation/calibration across protocols can be performed. So, if a WWW server responds in a number of ms, and a game server responds in the same number of ms, it can be determined that X may be good enough for WWW, but not for games. This is important in understanding user perception of performance.

The mping program is a specially optimized form of the familiar “ping” (ICMP echo) tuned for use with very large numbers of simultaneous destinations. It provides information on latency, packet loss, and reachability of the monitored destinations. Furthermore, data generated by mping is easily compared to the data provided from several years of using the Internet Weather Report.

Latency and packet loss information is obtained from the round-trip time of packets and the number of packets sent which return to the source. Packets are sent in groups (a group of pings a being called a bong). Reachability information is obtained from the number of bongs sent which do not return to the source.

There are some disadvantages to using only ICMP packets for monitoring. Routers often do not respond to them, and more and more ISPs are blocking them. Even when this is not the case, they are often treated differently than other packets generated by users, thus causing a need to take measurements using different protocols.

The mweb tool records several different measurements from the process of transferring web pages from a destination. These measurements include: the time taken to open a TCP connection to the server; the time taken to send a GET request; the time taken for the server to respond to the GET request (that is, the time taken before the first response byte is received); and the time taken to read the entire HTML page.

Data transferred in bulk creates streams along the path that are likely to have characteristic behavior different from that of either pings or HTTP packets. Mftp is used to measure the times to open a connection on the FTP command channel (port 21), initiate a transfer of data over the data channel (port 20) and complete a transfer of data over the data channel.

Msmtp retrieves the time elapsed for a mail server to respond to an SMTP HELO command on port 25.

Many Internet activities rely on DNS lookups in order to carry out their data transfer. The mdns tool is designed to monitor the availability and response times of those hosts offering DNS services.

A viewlist is used for viewing, i.e., examining collected data, in many cases according to small lists of carefully categorized destinations. In many cases a viewlist is constructed to contain a small list of carefully categorized destinations. Many viewlists are intended to be representative of either the Internet as a whole, or of segments of particular interest (e.g., specific ISPs, specific services, etc.). Viewlists may also overlap, and viewlists may be constructed ad hoc for whatever purpose. For example, a user might want to examine all destinations that are in Minnesota or all destinations with latency higher than the median.

As described above, a pinglist is used for pinging. Pinglists are implementation details used for data collection and storage efficiency. The same term is used regardless of whether the metric used with the pinglist is mping, mweb, or another.

A pinglist can be used as a viewlist. A pinglist may be constructed from several viewlists. Every viewlist could be used as a pinglist. However, it would be difficult to prevent overlapping pings of the same host from different lists. A pinglist may be composed of a discrete list of viewlists that add up to exactly fill the entire pinglist, as for example with viewlists for routers, supercore, PoPs, web servers, etc. for a particular ISP that together compose a pinglist for that ISP. This approach is convenient to administer, but not optimal because viewlists may overlap, and viewlists may be constructed ad hoc for whatever purpose after a pinglist has been constructed.

### Data Processing

The scanning approach described herein often yields complex streams of data that must be combined and summarized for any interpretation. Each data stream carries ongoing information which is defined by four parameters: ISP, beacon, metric, and pinglist.

A network-wide assessment of performance is performed by combining of multiple data streams. Metrics such as latency are known to vary dramatically over a wide range of values. In order to deal uniformly with idiosyncratic distributional characteristics of different metrics, data summaries preferably utilize medians rather than arithmetic mean. This minimizes the effect of outliers, yet still allows for rigorous statistical comparisons.

One detection strategy is to apply one or more software filters to individual data streams to identify events that may indicate problems in performance. The first generation detector flags an event whenever a current data point's value exceeds the value of the sliding average of its immediate predecessors by more than a specified factor. The parameters that govern this tool are the size of the averaging window, the amplitude threshold that indicates an event, the absolute minimum current data value that can trigger an event, and the absolute minimum difference between the current data value and the window average that can trigger an event. The amplitude threshold defines a ratio of current value to window average that must be exceeded for an event to be identified. The minimum data value and minimum difference between the data and the window average are absolute values rather than ratios. These can be used to prevent events from being flagged during quiescent periods when small variations of small data values would otherwise cross the amplitude ratio threshold. The averaging window is essentially a low pass filter whose bandwidth cutoff can be varied by changing the window width. This allows a certain amount of smoothing of the data before events are detected, but this strategy by its very nature detects events which are characterized by single data points of a relatively large amplitude.

A second generation detection filter is designed to detect longer duration phenomena. The strategy is again to pass a single data stream through a low pass filter with a specified frequency cutoff. A variety of filter types will be allowed in addition to the sliding average used in the initial detector in order to achieve better control of the power spectrum of the filtered data. Rather than defining an event as an amplitude spike as in the initial strategy, this filter will attempt to identify an event as the beginning of a longer duration peak in the data. To distinguish such events from long term upward trends, a slope threshold is used to flag events. First a least squares line is fitted to a window of the filtered data. An event is signalled if the slope of this line exceeds a threshold value. Once an event is signalled, no further events will be signalled until the slope of the line crosses a reset threshold (one such threshold being zero). This will avoid frequent retriggering due to data variations during a longer term event. The parameters governing this tool are the width of the filter kernel, the width of the least squares window, the event and reset slope thresholds, and the type of low pass filter to be used (Box, Butterworth, Sync, etc.).

Both forms of automated detection provide a basis for launching additional monitoring (from more beacons and/or at more frequent time intervals) when problem conditions arise.

Once the initial event detectors are in place, the process of working with customers and simulations can begin, in order to assess the correlation of the types of events detected with the phenomena of interest to the customers. Given the amount of information available from monitoring, it distinguishing a wide variety of phenomena is contemplated.

Isolation of problems to specific servers, routers, links, or interconnection points can be accomplished with embodiments of the present invention. Upon detection of an event, the data taken per destination for that scan, can be sorted by worst results per metric, for example, highest latency, highest packet loss, etc. Those are considered the problem routers. Routers that show up as problems as observed from several beacons are of significant interest. Once problematic routers are known, performance leading up to the problem can be graphed and investigation of previos problems performed.

Data may be presented in graphical formats for ready comprehension. Rolling 24-hour presentations are generated hourly, showing 24 hours of packet loss, latency and reachability as viewed from each individual beacon and from an aggregated view from all the beacons (packet loss, latency) and reachability with a resolution of 15 minutes. These graphs can show trends within and changes within an hour of them occurring.

Rolling 7-day graphs are generated daily, showing 7 days of packet loss, latency and reachability as viewed from each individual beacon and from an aggregated view from all of (or a specific subset of) the beacons with a resolution of 15 minutes. The weekly view provides an excellent presentation of regular medium-term trends (such as the common variations over each 24-hour period).

Latest hourly graphs are generated hourly, showing the last hour's packet loss, latency and reachability, as viewed from each individual beacon and from an aggregated view from all the beacons with a resolution of 15 minutes. The hourly presentation provides a high resolution of short term trends and changes within an hour.

Latest daily graphs are generated daily, showing the previous 24 hours (midnight to midnight, GMT) of packet loss, latency and reachability as viewed from each individual beacon and from an aggregated view from all the beacons with a resolution of 15 minutes.

Multi-ISP is generated hourly, showing 24-hour rolling graphs of packet loss, latency and reachability for each of six ISPs as viewed from each of several beacons.

The various presentations allow a direct comparison of performance between different ISPs over the same time periods.

Tables relate to median latency, packet loss, and reachability. Tables are generated hourly showing comparisons of a number of ISPs by median latency, packet loss and reachability. Median latency, packet loss and reachability graphs for the preceding 24-hours are generated for the five top and bottom ISPs as measured by each of these three metrics.

ISPs are included in the table from many different regions of the globe, possibly resulting in a bias in systems of few beacons in favor of those ISPs whose destinations are relatively near to the beacons. Thus, tables are also generated which compare just those ISPs within a given region, thereby providing accurate comparisons.

Packet loss presentations are generated daily showing details on packet loss to individual destinations and details on how the set of destinations responded over the last 24-hour period (midnight to midnight GMT). The presentation preferably includes break downs such as the following: number of destinations showing 0%, 0 to 1%, 1 to 2%, 2 to 99% and 100% packet loss; list of destinations showing 100% packet loss; responding destinations with relatively poor packet loss and graphs of packet loss for destinations showing particularly poor packet loss.

Although a good overview of network performance is provided through the HTML interface, certain permutations of data streams requires a more malleable interface. Such a malleable interface is available in the form of a Java Graph applet. The Graph Applet provides for hands on analysis of the data by network engineers. Any combination of data streams and metrics can be selected and displayed on the screen. The interface can be constantly developed to pinpoint and troubleshoot network performance problems.

Interpretation provides insight into the performance of a subscriber ISP and competing ISPs, and of the Internet at large. The system of the current invention provides information that aids in: detecting specific network problems quickly, both inside and outside the subscriber's network; displaying historical performance; predicting problems such as increasing congestion in certain links or need for more interconnections; and assisting with capacity planning characterization of performance-related events.

Another aspect of the invention relates to Net topology which differs from terrestrial geography. By way of explanation, the shortest distance between 2 points is a straight line. But everyone realizes that the road between any two locations is not likely to be a straight line. Paths traveled by Internet data are much more likely to be indirect than roads. Often packets move between source (Src) and destination (Dst) via a circuitous route. Sometimes -this is because that route is actually more efficient, due to congestion from other traffic on more direct routes (also familiar to anyone who commutes). Other times, indirect routes arise from the fact that packets must cross ISP boundaries to reach their Dst, and their options for paths of travel are limited by political and economic, rather than engineering considerations.

It is also noteworthy that the path from point A to point B is not necessarily the path from point B to point A. While the monitoring process of the present invention can measure “length” of the round trip point A to point B to point A, it is important to keep in mind the potential for asymmetric routes, such as a packet going from A to B, and returning via B to C to D to A.

Finally, the path between any Src and Dst pair is made up of links and nodes (mostly routers). While the distances that are traversed by links may be long, the transmission rate of packets over the links is extremely fast.

Geographic distances do have a significant effect on latencies over paths that span a substantial portion of the globe, and so there may be a substantial difference between the performance intra-continentally and inter-continentally.

However, most variation in latencies are influenced more by the time it takes to process them through the routers they meet along the path. The packet is more likely to get delayed in a router (due to the current load on that router from other traffic) than somewhere along a link, and packet loss almost never occurs in a cable. It is the variation in latency that is most useful in characterizing the reliability of the performance a customer can expect from an ISP. For this reason, understanding router behavior is key in interpretation of performance. To allow recording of attributes and values associated with the four elements which describe the data streams of one embodiment (isp, beacon, metric, pinglist) and other types of relevant data, a set of textual attributes is used, together with a Perl module to access them.

It is preferable that different types of attributes, such as attributes related to pinglists and attributes related to metrics, be held in different directories. Related attributes, such as attributes related to a pinglist and attributes to do with the mftp metric, will be held in related files. Attribute type directories can include /beacon/etc/attributes/isp/; /beacon/etc/attributes/beacon/; /beacon/etc/attributes/metric/; /beacon/etc/attributes/pinglist/; /beacon/etc/attributes/viewlist/; and /beacon/etc/attributes/style/. Each of those directories contains a number of text files, for example /beacon/etc/attributes/isp/psinet; /beacon/etc/attributes/isp/uunet.; /beacon/etc/attributes/beacon/jpc-1; /beacon/etc/attributes/beacon/mids-1; /beacon/etc/attributes/metric/mping; /beacon/etc/attributes/metric/mweb; /beacon/etc/attributes/pinglist/psinet; /beacon/etc/attributes/pinglist/bbn; or /beacon/etc/attributes/viewlist/psinet-web. These text files can be in the style of RFC 822 (“Standard for the format of ARPA Internet text messages.”), section 3 (ie Internet email header format). The files can be made to include only an RFC 822 style header and have no message body. An example is:

/beacon/etc/attributes/metric/mping

Name: Matrix IQ ICMP Latency and Packet Loss

Description: mping measures bi-directional latency and packet loss between the MIQ beacon and a pinglist of destination hosts, using a proprietary scheduling algorithm.

Binary: /usr/local/etc/mping

Source: bfs-1:/usr/local/src/mping

/beacon/etc/attributes/metric/mping

Attribute (aka header field) names, and the syntax of their values can be defined as required. The default syntax for an attribute value is preferably set to a “text” token, as defined in RFC 822, section 3.3.

### WORKING EXAMPLES

Attribute files for the pinglists of ISPs that are being rated are in /beacon/etc/attributes/pinglist containing the attributes Name: and HomePageURL,

$ cat/etc/attributes/pinglist/bbn

Name: GTE Internet

HomePageURL: http://www.gte.net

Accessing Attributes From Perl

There is a Perl module Attributes.pm whose source is located at /usr/local/sec/attributes/ and the installed version lives in /usr/local/lib/mids/.

This module contains a simple function to retrieve an attribute: getAttribute (Type, Name, Attribute) which returns the value of the Attribute for the given attribute-type, or “undefined”. For example, getAttribute(“pinglist”, “sinet”, “Name”) will return the value “Science Information Network”. It returns “undefined” if the attribute value can't be retrieved (because it doesn't exist or there's some error occurred) and the exported variable $AttError contains an explanation of what went wrong. For convenience, 4 functions have been defined to return attributes for particular strands of the data stream: getIspAttribute (Name, Attribute); getBeaconAttribute(Name, Attribute); getMetricAttribute (Name, Attribute); and getPinglistAttribute(Name, Attribute). Further, two functions which may be commonly used are defined for returning particular attributes in the pinglist strand: getPinglistName(Name); and getPinglistURL(Name). Specificly, one example is:

$ cat ./atttest.pl
#!/usr/local/perl/bin/perl
BEGIN {
push(@INC, “/usr/local/lib/mids”);
}
use Attributes;
print getPinglistName(“sinet-jp”). “\n”
. getPinglistURL(“bbn”) . “\n\n”;
print getAttribute(“pinglist”, “swip”, “Name”) . “\n”
. getAttribute(“pinglist”, “uunet”, “HomePageURL”) . “\n\n”;
produces the following output:
$ ./atttest.pl
Science Information Network
http://www.gte.net
The Swedish IP Network
http://www.uu.net

It should be understood that the present invention may be embodied in other specific forms without departing from the spirit or essential attributes thereof.

What is claimed is:

1. A method for monitoring network performance comprising:
defining and characterizing a population of interest;
choosing a set of destinations that represent the population;
creating at least one pinglist representative of the population;
monitoring the destinations in the pinglists from one or more beacons;
collecting information;
compiling the information to form data;
summarizing the data in ways that address questions of interest about the population; and
providing an appropriate interpretation of the analysis in terms of the questions of interest.
